(19) United States
(12) Patent Application Publication
(10) Pub. No.: US 2006/0078765 A1
(43) Pub. Date: Apr. 13, 2006

(54) Nano-structured ion-conducting inorganic membranes for fuel cell applications

(76) Inventors: Laixia Yang, Xi'an (CN); Jiusheng Guo, Fargo, ND (US); Bor Z. Jang, Fargo, ND (US)

Correspondence Address: Bor Z. Jang, 2902 28th Ave. SW, Fargo, ND, 58103, US

(21) Appl. No.: 10/962,556

(22) Filed: Oct. 12, 2004

(51) Int. Cl. H01M 8/00; H01M 2/14

(52) U.S. Cl. 429/12; 429/129

(57) ABSTRACT

An inorganic proton-conducting membrane and a fuel cell comprising this membrane. The fuel cell comprises a fuel anode, an oxidant cathode, and an inorganic proton-conducting membrane disposed between the anode and the cathode. The membrane is composed of a nano-structured network of proton-exchange inorganic particles. The particles form a sufficiently high density of proton-conducting nanometer-scaled channels with at least one dimension smaller than 100 nanometers so that ionic conductivity of the membrane is no less than 10⁻⁶ S/cm (mostly greater than 10^{-4 S}/cm ) at 25° C. or no less than 10⁻⁴ S/cm (mostly greater than 10⁻² S/cm) at 200° C. This inorganic membrane allows a hydrogen-oxygen fuel cell to operate at a higher temperature without the need (or with a reduced need) to maintain the membrane in a highly hydrated state. A higher operating temperature also implies a fast electro-catalytic reaction of a fuel (e.g., mixture of methanol and water) at the anode permitting a lesser amount of fuel to cross-over the membrane and, hence, a higher fuel utilization efficiency.

This invention is a result of a research project sponsored by the U.S. National Science Foundation SBIR-STTR Program. The U.S. government has certain rights on this invention.

### FIELD OF THE INVENTION

This invention relates to an ion-conducting membrane for fuel cell applications. The invention specifically relates to a nano-structured inorganic membrane that has a high density of proton-conducting nano-scaled channels for use in hydrogen-oxygen fuel cells, direct methanol fuel cell (DMFC), direct ethanol fuel cell (DEFC), and the like.

### BACKGROUND OF THE INVENTION

A fuel cell is a device which converts the chemical energy into electricity. A fuel cell differs from a battery in that the fuel and oxidant of a fuel cell are supplied from sources that are external to the cell, which can generate power as long as the fuel and oxidant are supplied. A particularly useful fuel cell for powering portable electronic devices is a direct methanol fuel cell (DMFC) in which the fuel is a liquid methanol/water mixture and the oxidant is air or oxygen. Protons are formed by oxidation of methanol at the anode (fuel electrode) and pass through a proton-exchange membrane (or polymer electrolyte membrane, PEM) from anode to cathode (oxidant electrode). Electrons produced at the anode in the oxidation reaction flow in the external circuit to the cathode, driven by the difference in electric potential between the anode and cathode and can therefore do useful work.

The electrochemical reactions occurring in a direct methanol fuel cell which contains an acid electrolyte are:
Anode: CH₃OH+H₂O→CO₂+6H⁺+6e⁻ (1)
Cathode: 3/2O₂+6H⁺+6e⁻→3H₂O (2)
Overall: CH₃OH+3/2O₂→CO₂+2 H₂O (3)

The DMFC and other proton-exchange membrane fuel cells (PEMFCs) typically use a hydrated sheet of a perfluorinated acid-based ionomer membrane as a solid electrolyte. A popular membrane is perfluorosulfonic acid (PFSA) commercially available from DuPont (under the trade name Nafion). PFSA and all of other sulfonated polymers rely on sulfonate functionalities (R—SO₃—) as the stationary counter charge for the mobile cations (e.g., H⁺). Currently, these materials, when used as a fuel cell membrane, suffer from three serious technical problems:

One problem is that this type of polymer membrane requires the presence of water for ion conductivity. Normally, increasing water content increases conductivity at all temperatures. However, when the fuel cell operates at a higher temperature (and hence, supposedly a better efficiency or reduced activation-induced over-voltage), the membrane dries out faster and requires a higher amount of water to keep it hydrated. This dependence on water is a drawback of membranes that rely on sulfonic acid groups for their conductivity. As long as PEM membranes are kept hydrated, they function well, but when they dry out, ionic resistance rises sharply. A wide variety of methods have been developed to keep membranes supplied with water. These methods typically require adding water as either vapor or liquid to the gas streams entering the cell or adding water directly to the membrane. In each case, it requires additional water-handling components and raises the system complexity and cost. If a proton-conducting membrane could be developed with improved water retention or reduced dependence on free moisture for proton conduction it would be possible to operate a PEM fuel cell with less or no water, and at higher temperatures. This would provide simpler, lighter fuel cell stack designs.

The second problem is particularly severe for the direct organic liquid fuel cell (e.g., DMFC and DEFC). This is associated with low fuel utilization efficiency due to methanol or ethanol crossover from the anode through the electrolyte membrane to reach the cathode without being utilized. Using DMFC as an example, methanol crossover substantially degrades the performance of DMFCs. The methanol that crosses over represents lost fuel value and, therefore, a lower fuel efficiency. Further, when that methanol arrives on the cathode side of the PEM, it is oxidized by the cathode electro-catalyst which depolarizes the electrode. Oxidation of the fuel at the cathode increases the amount of air, or oxygen, that the cell or stack requires, since one molecule of methanol oxidizing on the cathode requires the same 1.5 oxygen molecules as one being consumed at the anode. None of the energy from this oxidation is used to produce electrons and, hence, it all ends up as waste heat, increasing the cooling load on the cell. A PEM with substantially reduced methanol crossover would represent a significant improvement in the performance of a DMFC. Similar concepts are applicable to DEFC and other direct organic liquid fuel.

Additionally, as a third problem, a fuel cell containing a PFSA-type PEM has exhibited poor performance due to low electrode reactivity. The electro-chemical reactivity can be significantly improved if the fuel cell is allowed to operate at much higher temperatures. In addition, a faster reaction could lead to a reduction in fuel cross-over since there will be less fuel available for diffusion through the membrane. Unfortunately, PFSA-type membrane materials cannot be used at high temperatures (e.g., higher than 100° C.) for an extended period of time without degradation.

Several alternative approaches to using sulfonated polymers for proton conductors have been proposed. For instance, a wide variety of metal oxides have been recognized as proton conductors, generally in their hydrated or hydrous forms. These oxides include (1) hydrated precious metal containing oxides, such as RuOx (H₂O)ₙ and (Ru—Ti)Oₓ(H₂O), (2) acid oxides of the heavy post transition elements, such as acidic antimony oxides and tin oxides, (3) the oxides of the heavier early transition metals, such as Mo, W, and Zr, and (4) mixed oxides of the above-cited elements. Additional oxides which do not fit this description, such as silica (SiO₂) and alumina (Al₂O₃), may also be used.

All of the oxides described above are potentially useful as proton conductors, provided they could be fabricated into sufficiently thin sheets so that the conductance would be similar to that of a conventional polymeric membrane. The inability to produce thin sheets has been a key weakness of materials produced by the method used by Nakamora et al. (U.S. Pat. No. 4,024,036, May 17, 1977). In addition to inorganic cation conductors, inorganic-organic composite membranes are potentially useful for fuel cell applications. This approach has been followed by Stonehart, et al. (U.S. Pat. No. 5,523,181, Jun. 4, 1996); Takada, et al. (U.S. Pat. No. 5,682,261, Oct. 28, 1997); and Grot, et al. (U.S. Pat. No. 5,919,583, Jul. 6, 1999). The pros and cons of this approach have been reviewed by Murphy, et al. (U.S. Pat. No. 6,059,943, May 9, 2000 and U.S. Pat. No. 6,387,230, May 14, 2002), who disclose a cation-conducting composite membrane, comprising a polymeric matrix filled with inorganic oxide cation exchange particles forming a connected network extending from one face of the membrane to another face of the membrane.

Although the approach proposed by Murphy, et al. represents a significant improvement over conventional PFSA PEM or other polymer-filler composite approaches, it still has the following drawbacks: (1) Since the polymer is the continuous matrix with the inorganic particles dispersed therein, there is only limited volume of channels through which ions can transport. This is the case whether the ion-conducting channels run through the interior of the individual particles or through the interface between these particles and the polymer phase. As illustrated in FIG. 8 of U.S. Pat. No. 6,059,943, there exists only a limited number of connected chains or networks of particles between the left-hand side and the right-hand side of the membrane. In addition, those isolated particles (not a part of a chain) would not significantly contribute to ion conductivity. (2) The polymer represents the majority phase of the composite structure and, hence, the end-use temperature of such a composite membrane is limited by the thermal stability of the polymer. Although the ionic conductivity of this composite can be very high, its high-temperature durability is questionable. In order to fundamentally improve the high-temperature ion-conducting performance of a composite membrane, the matrix or majority phase cannot be a polymer and, preferably, should be an inorganic material.

Therefore, one object of the present invention is to provide an ion-conductive inorganic membrane that can be used in an electrochemical device such as a fuel cell or a battery.

Another object of the present invention is to provide a nano-structured membrane that has a high density of ion-conducting channels through which cations such as H⁺ can readily transport.

It is a further object of the present invention to provide a high-temperature ion-conducting membrane for use in a fuel cell that operates at a higher temperature (e.g., at 100-150° C. for a DMFC and higher than 200° C. for other types of fuel cells such as a phosphorous acid fuel cell).

A specific goal of the present invention is to provide an inorganic or inorganic matrix composite membrane that can be used in a DMFC for reduced fuel crossover and improved cell performance.

### BRIEF SUMMARY OF THE INVENTION

The present invention provides an inorganic proton conducting membrane and a fuel cell containing such a membrane. The fuel cell is mainly composed of a fuel anode, an oxidant cathode, and a proton-conducting membrane disposed between the anode and the cathode. The membrane is unique in that it is based on an inorganic material such as an oxide-based super-acid that can be used at a relatively high temperature (e.g. 150° C. or higher) that is otherwise not possible with a PSFA-type of polymer membrane. The membrane comprises a nano-structured network of proton-exchange inorganic particles, characterized in that the particles form a sufficiently high density of proton-conducting nanometer-scaled channels (with at least one dimension smaller than 100 nanometers) so that ionic conductivity of the membrane is no less than 10⁻⁶ S/cm (mostly greater than 10⁻⁴ S/cm ) at 25° C. or no less than 10⁻⁴ S/cm (mostly greater than 10⁻² S/cm) at 200° C. Such a high temperature allows a hydrogen-oxygen fuel cell to operates very efficiently without the need (or with a reduced need) to maintain the membrane in a highly hydrated state. A fast electro-catalytic reaction of a fuel (e.g., mixture of methanol and water) at the anode due to a higher operating temperature also implies a lesser amount of fuel available for crossover and a higher fuel utilization efficiency.

### BRIEF DESCRIPTION OF THE DRAWINGS

FIG. 1 A cross sectional view showing the major components of a fuel cell.

FIG. 2 A cross sectional view showing the major components of a fuel cell unit (of a multiple-unit fuel cell system) that further comprises bipolar plates.

FIG. 3 (a) A nano-structure that comprises a network of highly close-packed nano-sized particles forming a high density of proton-conducting channels through the particle bulk or through the interface zones between particles (also referred to as the interstitial spaces not occupied by these particles); (b) a nano-structure similar to that in (a), but with a slightly less close-packed nano particles, permitting larger interstitial spaces to facilitate surface conductivity of protons; (c) a network of partially sintered nano particles; and (d) a nano-structure that is composed of nano-sized phases, domains, grains, or crystallites with a large fraction of grain-boundary or interfacial zones for facile proton migration.

FIG. 4 A possible surface conductivity mechanism for protons.

FIG. 5 The voltage-current responses of a presently invented fuel cell based on an inorganic thin film membrane and a baseline fuel cell based on a PSFA membrane.

### DETAILED DESCRIPTION OF THE INVENTION

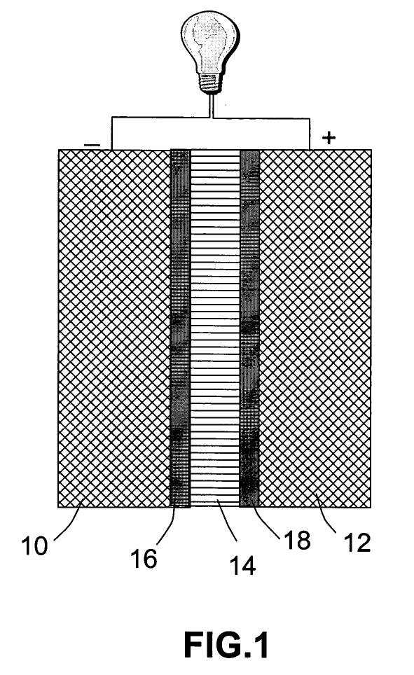

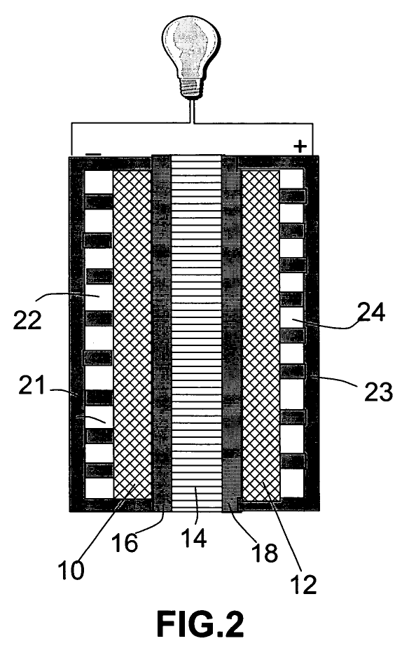

The present invention provides an inorganic proton-conducting membrane that can be used at a relatively high temperature and a fuel cell comprising such a membrane. The fuel cell, schematically shown in FIG. 1, comprises a fuel anode 10, an oxidant cathode 12, and a proton-conducting membrane 14 disposed between the anode and the cathode. Normally, an anode electro-catalyst layer 16 is implemented between the membrane 14 and the anode 10 to promote the anode electro-chemical reaction. Also, a cathode electro-catalyst layer 18 is implemented between the membrane 14 and the cathode 12 to promote the cathode reaction. In a stack of multiple-unit fuel cell system, each unit cell may further comprise bipolar plates (such as 21, 23 in FIG. 2) which contain fuel diffusion channels 22 and oxidant diffusion channels 24, respectively.

The proton-conducting membrane 14 comprises a nano-structured network of proton-exchange inorganic particles, phases, crystallites, or domains that have at least one dimension on the nanometer scale (<100 nm). These particles form a high density of proton-conducting nanometer-scaled channels with at least one dimension smaller than 100 nanometers so that an ionic conductivity of the membrane is no less than 10⁻⁶ s/cm (preferably greater than 10⁻⁴ s/cm) at 25° C. or no less than 10⁻⁴ s/cm (preferably greater than 10⁻² s/cm) at 200° C. These proton-conducting channels are constituted by (a) the interfaces or pores between essentially nanometer-sized particles, (b) the bulk of these particles, or (c) combinations of interfaces and particle interiors.

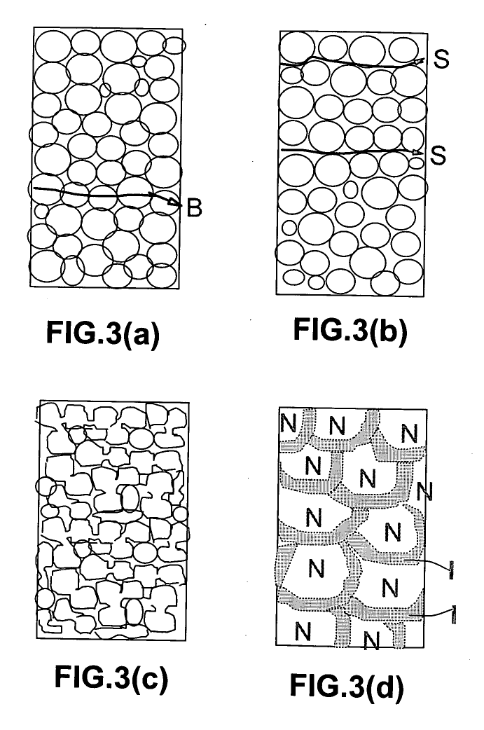

In one preferred embodiment, the nano-structured network of proton-exchange inorganic particles are formed by packaging together nanometer-sized inorganic powder particles or depositing nano-crystallites (nano-scaled grains, phases, or domains) to form a nano-crystalline structure. These particles or grains may form four types of nano-structures as schematically illustrated in FIGS. 3(a), 3(b), 3(c), and 3(d), respectively, and their combinations.

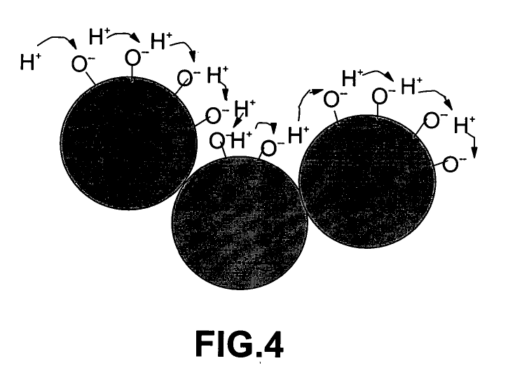

In FIG. 3(a), substantially nanometer-sized ion-exchange particles (e.g., proton-conducting metal oxide particles) are closely packed together with most of the nano particles being in physical contact with 1-12 neighboring particles to form a network or interconnected chains of particles. For those particles that are capable of transporting ions through their interior (bulk conductivity mechanism, denoted as B in FIG. 3(a)), this network provides a large number of essentially continuous ion migration paths on the nanometer scales (hereinafter also referred to as ion-conducting nano channels). Such a network of particles typically has a packing factor of approximately 0.5-0.75 (particles occupying a volume no less than 50% of the total membrane space), leaving behind approximately 25%-50% of “free volume” between particles. This free volume actually may be characterized by having a high density of interconnected nano-scaled pores or channels. If ion transport occurs primarily on the surface of these particles (surface conductivity mechanism, designated as S in FIG. 3(b)), these interconnected channels provide low-resistance paths for the mobile ions (e.g., H⁺). A possible surface conductivity mechanism is the Grothaus proton hopping mechanism, schematically illustrated in FIG. 4, which is the same process commonly believed to account for the proton conductivity in PFSA membranes, polyphosphoric acid, and tungstic acid. The particle network nano-structure schematically shown in FIG. 3(b) is similar to that in FIG. 3(a), but with a slightly lower packing factor, allowing greater interface areas for larger surface conductivity channels.

The nano particles in FIG. 3(c) are shown to be partially sintered, forming a network of more or less interconnected particles that exhibit improved mechanical integrity. Nano-scaled particles are known to exhibit a much lower sintering temperature as compared with their larger-sized counterparts. Hence, partial sintering can be readily accomplished without consuming much energy. A small amount (preferably 0.5-5% by volume) of organic binder material (such as a proton conducting polymer) may be sprayed onto or impregnated into the particle networks shown in FIGS. 3(a) and (b) to consolidate the particles together, essentially forming a “composite” membrane with an inorganic matrix (or continuous phase) and a dispersed polymer phase. This is in contrast to the polymer composite membrane of Murphy, et al (U.S. Pat. No. 6,059,943), wherein the polymer is the continuous phase or matrix while the minority or dispersed phase is the inorganic particles. The proton conducting polymer may be selected from the group consisting of perfluorosulphonic acid, polytetrafluoroethylene, perfluoroalkoxy derivatives of polytetrafluoroethylene, polysulfone, polymethylmethacrylate, silicone rubber, sulfonated styrene-butadiene copolymers, polychlorotrifluoroethylene (PCTFE) perfluoroethylene-propylene copolymer (FEP), ethylene-chlorotrifluoroethylene copolymer (ECTFE), polyvinylidenefluoride (PVDF), copolymers of polyvinylidenefluoride with hexafluoropropene and tetrafluoroethylene, copolymers of ethylene and tetrafluoroethylene (ETFE), polyvinyl chloride, and mixtures thereof. These polymers are, by themselves, good proton conductors and have been used as a membrane material in a fuel cell. In the presently invented fuel cell membrane, such a polymer, if existing, is only a minority component and will not significantly impact the fuel cell performance at a temperature higher than 100° C., up to the melting point of this polymer.

FIG. 3(d) schematically shows a nano-crystalline structure featuring nano-scaled grains, domains or crystallites (also commonly referred to as nano particles or nano-crystallites), denoted as N, and interface zones, denoted as I, between two nano crystallites N. These interface zones I have a large free volume and are fast ion diffusion channels, referred to as nanometer channels. Nano-structured materials are known to possess larger grain boundary or interface areas that are normally less ordered or more amorphous.

The nano-structures as schematically illustrated in FIGS. 3(a)-3(d) can be controllably varied to meet desired fuel cell membrane performance requirements. For instance, the nano ion channels may be functionalized or properly sized to specifically facilitate migration of protons only, excluding other chemical species (e.g., methanol fuel) from passing through.

The presently invented inorganic solid electrolyte, being good proton conductors, can be used in all fuel cells that depend on the transport of protons, including PEM-FC (using hydrogen as a fuel and oxygen as an oxidant), direct organic liquid fuel cells (e.g., DMFC and DEFC), and phosphoric acid fuel cell (PAFC). This is despite the notion that DMFC is being used herein as a primary example for illustration purposes. In the case of a PAFC, the presently invented inorganic nano-structure material may be impregnated with phosphoric acid to make an electrolyte that can operate at a temperature much higher than 200° C., which is otherwise normally considered as an upper limit for a PAFC. When operating at a significantly higher temperature that 200° C., the CO poisoning of the electro-catalyst is no longer a problem and the PAFC can make use of much less expensive catalyst materials such as Ni than Pt.

Nano-scaled oxide particles can be produced by high-intensity ball milling of micron-scaled particles, gas-assisted vapor condensation, and sol-gel processes. Partially sintered nano-structures and nano-crystalline structures can be formed directly using processes such as sputtering, plasma arc assisted deposition, and laser-assisted vapor deposition with a controlled-temperature substrate.

In one preferred embodiment, the inorganic particles comprise selected metal oxides. This group of materials can be summarized as those elements forming insoluble hydrated oxides that include not only known proton conductors, but also oxide superacids that will furnish a multitude of free protons in the presence of an aqueous medium. These are Y, La, Ti, Zr, Hf, Nb, Ta, Mo, W, Re, Ru, Os, Rh, Ir, Pd, Pt, Si, Ge, Sn, Pb, Sb, and Bi. Many other elements which are not included in this list may be useful in conjunction with these elements as modifiers. An example of this is the inclusion of phosphorus in the structure of Keggin ions which consist primarily of a tungsten or molybdenum oxide framework. While the compounds encompassed in the description above have some degree of proton mobility, not all of those oxides have adequate proton mobility to be useful as components in the inorganic membrane. Some particularly useful examples are described below.

Zirconium phosphate, specifically α-zirconium phosphate powder, is known to be an excellent proton conductor at ambient temperature. The compound powder is hydrated Zr(HPO)₂(H₂O), and most of the conductivity is the result of protons migrating over the surface of the individual crystallites. Above 120° C., the water of hydration is lost and the conductivity drops substantially to a value comparable to the bulk conductivity of the solid. This bulk conductivity increases from 1.42×10⁻⁶ S/cm at 200° C. to 2.85×10⁻⁶ S/cm at 300° C., which gives an acceptable ion conductivity if the membrane layer is sufficiently thin. With this combination of properties, α-zirconium phosphate is suitable for use in either low temperature (<100° C.) fuel cells, or in higher temperature (>150° C.) fuel cells. It may be noted that hafnium, titanium, lead and tin all have phosphates that crystallize in a structure similar to that of α-zirconium phosphate. These compounds have substantially less free volume in their structures than the zirconium compound, and should have lower proton mobilities.

Two groups of proton conductors are derived from tungsten and molybdenum. The first group consists of simple, fully oxidized metals such as tungsten trioxide (WO₃). This oxide can be repeatedly reduced and oxidized electrochemically in the solid state in a reversible manner. This reaction occurs without any significant rearrangement of the crystal lattice. Consequently, maintaining charge neutrality requires a cation (proton) to diffuse into the structure and reside on an interstitial site. By maintaining an appropriate bias across an oxide film, a proton flux can be maintained.

The second group of tungsten and molybdenum compounds with high proton conductivity are the hetero⁻ and homo⁻ polymolybdates and polytungstates. This group includes a broad range of compounds with widely varying compositions, all of which are based on the fusion of groups of MO₆ (M═Mo, W) octahedra by edge or corner sharing. These ions have a generic formula of (X^{k+}MₙO₍₃ₙ₊ₘ₎)^{(2m-k)-} where k is the positive charge of the heteroatom, if any, and m is the number of unshared octahedral corners in the structure. The large cage in the center of the ion can host a heteroatom, such as P or As, which lowers the net charge on the ion. The exact structure formed is a function of temperature and pH, with interconversion between frameworks occurring with changing conditions.

Compounds in this family have been demonstrated to have room temperature proton conductivities as high as 0.17 S/cm for H₃W₁₂PO₄₀.29 H₂O and 0.18 S/cm for H₃Mo₁₂PO₄₀.29 H₂O. These conductivity values are over an order of magnitude greater than that of PFSA membrane like Nafion measured under the same conditions. These compounds have the thermal stability to remain proton conducting above 200° C., although with a reduced conductivity. If silica gel is doped with H₃W₁₂PO₄.29 H₂O while it is being formed from tetra-ethoxysilane (TEOS) by a sol-gel reaction, the product is an amorphous proton conductor with a conductivity that varies with the concentration of the tungstate, which may be present at up to about 50 percent by weight. The above acids may be used in solid form, as either the pure acids, or in combination with a salt of the acid. Nano-structured networks of proton-exchange particles can be prepared by sputtering using the desired acid or acid salt as the sputtering target material. The resulting film typically has a sub-micron or nanometer-sized thickness. The substrate temperature may be varied in such a fashion that the nano-structure formed comprises interconnected pores or interface spaces for protons to migrate through. Alternatively, the substrate temperature may be controlled, along with post-deposition heat treatments, to obtain a nanometer thin, pinhole-free film that is essentially nano-crystalline with a great amount of interface zones between nano-sized grains, as schematically shown in FIG. 3(d). The interface zones provide a fast diffusion paths for protons. Like tungsten and molybdenum, tantalum and niobium form highly charged complex polyanions. These materials are also facile cation exchange membranes capable of proton conduction.

The above phosphomolybdic acid type of structures fall into a broad category of heteropoly acids represented by the generic formula of Hₘ[Xₓ.Y_{y}.O_{z}].nH₂O (and their salts), wherein, X stands for at least one member selected from the group consisting of boron, aluminum, gallium, silicon, germanium, tin, phosphorus, arsenic, antimony, bismuth, selenium, tellurium, iodine and transition metals belonging to the fourth, fifth and sixth periods of the Periodic Table, Y is at least one member selected from transition metals belonging to the fourth, fifth, and sixth periods of the Periodic Table, and wherein m has a value of from 2 to 10, y has a value of from 1 to 12, n has a value of from 3 to 100 all based on X taken as 1 and z has a positive numerical value. These materials were demonstrated by Nakamura, et al. (U.S. Pat. No. 4,024,036) to be excellent proton conductors with room temperature conductivity in the range of 2×10⁻⁴ to 2×10^{31 1} s/cm. However, they were also known to be extremely difficult to be fabricated into thin film forms, as pointed out by Murphy, et al. in U.S. Pat. No. 4,024,036. After diligent research and development work, we have demonstrated that they can be made into thin film form using processes such as sputtering, or ball milling followed by powder thermal spraying. These materials are now viable proton exchange membrane materials for fuel cell applications.

The oxoacids of antimony are also known to have high proton conductivity. These compounds have a structure consisting of edge or corner shared SbO₆ octahedra. Unshared oxygens are protonated (i.e., hydroxyls) and charge neutrality is maintained by exchangeable external cations. In these acids, antimony can be in either the +3 or +5 oxidation states, or a mixture of the two, depending on the synthesis conditions and subsequent treatment. Thin films of antimonic acid can be produced on conductive surfaces by electrophoretically depositing fine particles suspended in a solution of ammonium hydroxide in acetone. These thin films can be used as a fuel cell membrane, which can operate up to approximately 150° C.

The above-cited inorganic materials have four common features that make them suitable for use as proton conducting electrolytes in fuel cells. First, they all have easily exchangeable protons. Second, they all have network structures of nano particles with channels to provide fast paths for the mobile protons to move along. Third, they all retain their proton conductivity at temperatures in excess of 140° C. (in most cases, in excess of 200° C.). In many cases, their proton conductivity values at T<100° C. are reasonable, making them suitable for fuel cells that operate at both high and low temperature ranges. Fourth, they all can be fabricated into thin films with a thickness smaller than 10 μm (and even smaller than 1 μm, if a miniaturized fuel cell is needed). Such an ultra-thin electrolyte layer (<1 μm) cannot be readily obtained when a polymer or polymer matrix composite is used as the proton exchange membrane. This is one of the several significant advantages of the presently invented nano-structured inorganic membrane materials.

Sulfated zirconia, titanium oxides, and titanium-aluminum oxides are essentially amorphous solid super acids with sulfate groups attached to their surface. One method to produce this type of material is precipitation of amorphous Zr(OH)₄ by treating an aqueous solution of a zirconium salt with a base followed by sulfonation of the gel with either sulfuric acid or ammonium sulfate. The amorphous Zr(OH)₄ can also be produced by a sol-gel method, and sulfated in the same manner. Higher surface area materials can be produced by the direct reaction of sulfuric acid with the alkoxide precursor. Although these materials are strong Bronsted acids, like PFSA materials, they require water for the formation of free protons.

Solid membranes with similar properties can also be produced with zirconia being replaced by alumina (Al₂O₃). These materials are produced by combining a salt, such as Li₂SO₄ or RbNO₃, with the corresponding aluminum salt and sintering the mixture to convert the aluminum salt to an alumina matrix. The guest salt remains relatively unchanged. These materials can be pressed to form a target that is used in a vacuum sputtering process to produce a thin film membrane. When these materials are used as an electrolyte, a single-cell fuel cell exhibits a voltage of 0.75 V observed at current densities of 200 mA/cm².

For all of the afore-mentioned materials, the proton conductivity is greater than 10⁻⁶ S/cm at 25° C. (mostly greater than 10⁻⁴ S/cm) or greater than 10⁻⁴ S/cm (mostly greater than 10⁻² S/cm) at 200° C. In order to ensure a high fuel cell operating voltage during discharge, resistive losses across the electrolyte film must be minimized. The resistive loss across a conductive film can be calculated according to Ohm's Law V=IR. To ensure that voltage drop across the thin film is less than 100 mV at 5 mA/cm², the resistance of the film should be less than 20 Ωcm². For a 1,000 angstrom (Å) thick film the maximum resistivity of the film is then calculated as R=ρl/A, ρ=RA/l=20 (1)/0.00001 cm=2×10⁶ Ωcm. Therefore the conductivity of the film is preferably greater than 5×10⁻⁷ siemens/cm (S/cm or Ω⁻¹cm⁻¹). In the worst case of the materials studied, the proton conductivity is greater than 10⁻⁶ S/cm at 25° C. Hence, this material would be an acceptable fuel cell membrane material provided the membrane can be made into a thin film with a thickness of 2,000 Å (0.2 μm). This thickness is demonstrated herein to be achievable with all the materials studied using sputtering. For a 10 μm thick film, the ion conductivity must be greater than 5×10⁻⁵ siemens/cm. Most of the materials developed herein meet this requirement. If a smaller voltage drop across a 10 μm membrane is desired (e.g., <10 mV), then the ion conductivity of the electrolyte layer must be greater than 5×10⁻⁴ siemens/cm at room temperature. This requirement is also met by a majority of the materials herein developed.

### EXAMPLE 1

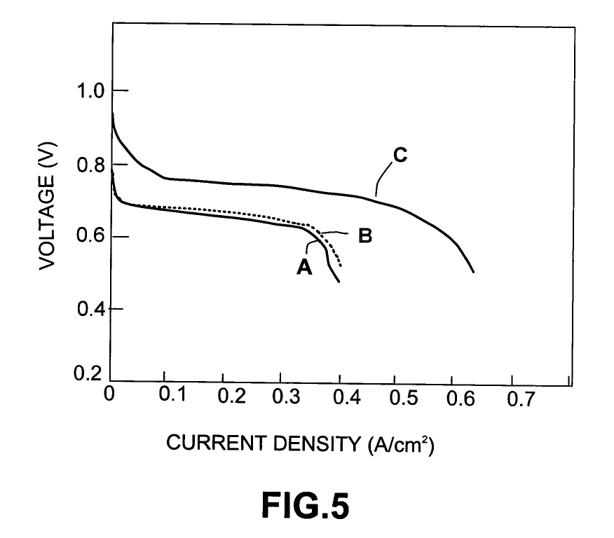

A fuel cell was prepared as follows. A sheet of carbon paper was coated on one side with a Pt—Ru catalyst to give an anode of 32 mm×32 mm in dimensions. A carbon paper was coated with a platinum (Pt) black catalyst to give a cathode also of 32 mm×32 mm. The Pt-coated carbon paper was then placed in a sputtering chamber to serve as a substrate. A piece of H₃[P.Mo.O₄₀].30H₂O crystal was used as a sputtering target. A thin film with a thickness of approximately 0.5 μm was deposited onto the substrate for use as a thin solid electrolyte layer. This inorganic electrolyte membrane was then pressed against the catalyst side of the anode layer in such a way that the membrane is sandwiched between the anode and the cathode, with the catalyst layers on both electrodes being in contact with the electrolyte membrane. The assembly was joined together by pressing for 5 minutes under a pressure of 20 kg/cm², to give a power generating section. The resulting assembly was held between a cathode holder and an anode holder, the former having oxidant gas feeding grooves each having a depth of 2 mm and a width of 1 mm. The obtained unit cell has a reaction area of 10 cm². The fuel cell was supplied with a methanol-water mixture at an 1:3 molar ratio as a liquid fuel. The air at 1 atm as an oxidant gas was fed into the gas channels at a flow rate of 100 mL/min so that the fuel cell generated electricity at 76° C. This fuel cell gave a current-voltage characteristic curve (Curve A) as shown in FIG. 5. When operating at 150° C., this fuel cell exhibits an impressive response as shown in Curve C of FIG. 5, operable at a higher output voltage and greater current densities.

### COMPARATIVE EXAMPLE 1

A fuel cell of the prior-art type was prepared that has a similar configuration as that in Example 1. However, the membrane was a PFSA sheet of approximately 2 mm thick. The fuel cell thus obtained was supplied with a methanol-water mixture mixed at a 1:3 molar ratio as a liquid fuel. The liquid fuel was introduced by the capillary action through the side of the anode. The air at 1 atm as an oxidant gas was fed into the gas channels at a flow rate of 100 mL/min so that the fuel cell generated electricity at 79° C. (measured at the catalyst/electrolyte interface). This fuel cell gave a current-voltage characteristic curve as indicated in Curve B of FIG. 5. This fuel cell failed after operating at 150° C. for less than two hours due to membrane degradation.

The three curves shown in FIG. 5 demonstrate that the fuel cells in both examples produce a stable output voltage at 76-79° C. until the current reaches about 3.5 A (equivalent to a current density of 0.35 A/cm²). The two fuel cells are quite similar in performance in this low temperature range. It was found that, in general, the higher the reaction temperature, the higher the output voltage was. But, a PFSA-type membrane cannot be used in a temperature higher than 100° C. At 150° C., the fuel (water and methanol mixture) is in a vaporous state and, hence, a higher electrolytic reaction rate at the anode (Equation 1) is achieved. This is in favor of a more stable and higher voltage response as a function of current density by way of an increased reactivity (faster and more efficient fuel conversion) and reduced chance of fuel cross-over.

1. A fuel cell comprising a fuel anode, an oxidant cathode, and a proton-conducting membrane disposed between said anode and said cathode, wherein said membrane comprises a nano-structured network of proton-exchange inorganic particles, characterized in that said particles form a sufficiently high density of proton-conducting nanometer-scaled so that ionic conductivity of said membrane is no less than 10⁻⁶ S/cm at 25° C. or no less than 10⁻⁴ S/cm at 200° C.

2. The fuel cell of claim 1, wherein the inorganic particles occupy a volume fraction of no less than 50%.

3. The fuel cell of claim 1, wherein ionic conductivity of said membrane is no less than 10⁻⁴ S/cm at 25° C. or no less than 10⁻² S/cm at 200° C.

4. The fuel cell of claim 1, wherein the inorganic particles comprise at least one hydrated metal oxide.

5. The fuel cell of claim 4, wherein the hydrated metal oxide contains a metal selected from molybdenum, tungsten, zirconium, titanium, ruthenium, or mixtures thereof.

6. The fuel cell of claim 1, wherein the inorganic particles are selected from the group consisting of heteropolytungstates, heteropolymolybdates, complex polyanions of tantalum and niobium, zirconium phosphates, hafnium phosphates, lead phosphates, tin phosphates, antimonic oxoacids, and mixtures thereof.

7. The fuel cell of claim 1, wherein the inorganic particles comprise nanometer-scaled particles.

8. The fuel cell of claim 1, wherein the inorganic particles comprise nanometer-scaled particles that are partially sintered.

9. The fuel cell of claim 1, wherein said nano-structured network of proton-exchange inorganic particles comprise a nano-crystalline structure.

10. The fuel cell of claim 1, wherein said nano-structured network of inorganic particles is impregnated with a proton-conducting organic material.

11. The fuel cell of claim 10, wherein said proton-conducting organic material comprises a synthetic organic polymer selected from perfluorosulphonic acid, polytetrafluoroethylene, perfluoroalkoxy derivatives of polytetrafluoroethylene, polysulfone, polymethylmethacrylate, silicone rubber, sulfonated styrene-butadiene copolymers, polychlorotrifluoroethylene (PCTFE) perfluoroethylene-propylene copolymer (FEP), ethylene-chlorotrifluoroethylene copolymer (ECTFE), polyvinylidenefluoride (PVDF), copolymers of polyvinylidenefluoride with hexafluoropropene and tetrafluoroethylene, copolymers of ethylene and tetrafluoroethylene (ETFE), polyvinyl chloride, or mixtures thereof.

12. The fuel cell of claim 1, wherein the inorganic particles are selected from the oxides of molybdenum, tungsten, ziroconium, titanium, ruthenium, or mixtures thereof.

13. The fuel cell of claim 1, wherein the inorganic particles are selected from the group consisting of heteropoly acids represented by the generic formula Hₘ[Xₓ.Y_{y}.O_{z}].ₙH₂O and salts of said acids, wherein, X stands for at least one member selected from the group consisting of boron, aluminum, gallium, silicon, germanium, tin, phosphorus, arsenic, antimony, bismuth, selenium, tellurium, iodine and transition metals belonging to the fourth, fifth and sixth periods of the Periodic Table, Y is at least one member selected from transition metals belonging to the fourth, fifth, and sixth periods of the Periodic Table, and wherein m has a value of from 2 to 10, y has a value of from 1 to 12, n has a value of from 3 to 100 all based on X taken as 1 and z has a positive numerical value.

14. The fuel cell of claim 1, wherein the inorganic particles comprise at least one oxide superacid or oxides with highly hydrated surfaces.

15. The fuel cell of claim 14, wherein the oxide superacid is selected from sulfated zirconia, sulfated alumina, sulfated titanium oxide, or sulfated titanium-aluminum oxide.

16. The fuel cell of claim 1, wherein said membrane has a thickness smaller than 10 μm.

17. The fuel cell of claim 1, wherein said membrane has a thickness smaller than 1 μm.

18. A multiple-unit fuel cell system comprising at least one fuel cell unit as defined in claim 1.

19. The fuel cell of claim 1, further comprising at least a bipolar plate comprising a fuel diffusion channel and/or an oxidant diffusion channel.

20. The fuel cell of claim 1, wherein said nano-structured network of inorganic particles is impregnated with phosphoric acid so that said fuel cell is a phosphoric acid fuel cell.

21. A proton-conducting membrane comprising a nano-structured network of proton-exchange inorganic particles, characterized in that said particles from a sufficiently high density of proton-conducting nanometer-scaled so that ionic conductivity of said membrane is no less than 10⁻⁶ S/cm at 25° C. or no less than 10⁻⁴ S/cm at 200° C.

22. A fuel cell comprising a membrane as defined in claim 21, said fuel cell being selected from the group consisting of a hydrogen-oxygen proton-exchange membrane fuel cell, a direct methanol fuel cell, a direct ethanol fuel cell, and a direct organic liquid fuel cell.
